(19) United States
(12) Patent Application Publication
(10) Pub. No.: US 2010/0250368 A1
(43) Pub. Date: Sep. 30, 2010

(54) SYSTEM AND METHOD OF MOBILE DEVICE ADVERTISING

(75) Inventor: Gino Porco, Etobicoke (CA)

Correspondence Address: LANG MICHENER, BROOKFIELD PLACE, P.O. BOX 747, SUITE 2500, 181 BAY STREET, TORONTO, ON, M5J 2T7, CA

(73) Assignee: MY SCREEN MOBILE INC., Toronto, ON (CA)

(21) Appl. No.: 12/665,850

(22) PCT Filed: Nov. 2, 2007
(86) PCT No.: PCT/CA2007/001970

§ 371 Date: Jun. 15, 2010

Related U.S. Application Data
(63) Continuation-in-part of application No. 11/766,860, filed on Jun. 22, 2007.

(30) Foreign Application Priority Data
Jun. 27, 2007 (CA) 2593725

(51) Int. Cl. G06Q 30/00

(52) U.S. Cl. 705/14.58; 705/14.4

(57) ABSTRACT

The invention consists of a method of advertising on mobile devices, comprising the steps of: a) collecting registration information from a user, the registration information including demographic, geographic and chronological information about the user; b) creating an advertising block containing one or more advertisements based on the user's demographic and geographic information; c) sending the advertising block to a mobile device designated by the user, at times determined by the user's geographic and chronological information; d) tracking and recording viewing of advertisements in the advertising block by the user; and e) compensating the user based on the viewing records for the advertisements within the advertisement block. The invention further consists of a system for providing mobile device advertising according to the method.

### FIELD OF THE INVENTION

The present invention relates to the field of advertising. In particular, it relates to a system and method of advertising over mobile devices.

### BACKGROUND OF THE INVENTION

Cellular/Personal Communications Service (C/PCS) provides audio, video and/or electronic data communications, including wireless mobile telephony service, wireless mobile data transmission service and wireless mobile global computer network (e.g., Internet) service. Presently, the most common form of C/PCS is hand-held mobile radiotelephone service and it is estimated that there are approximately 1.4 Billion worldwide mobile devices in use. To obtain these services, customers, referred to herein as “carrier network subscribers,” register with a particular service provider, referred to herein as a “carrier”. Upon registration, the carrier's network is configured to acquire and route communications initiated or received by the carrier network subscriber's personal wireless mobile device. The carrier network subscriber can then initiate and receive communications from any mobile location within the operator's wireless network service area, or those areas offering network interconnectivity.

Typically, wireless mobile devices are assigned a unique International Mobile Station Identifier (IMSI) or other similar identifying code or number, referred to herein as a “Subscriber Identification Code.” The Subscriber Identification Code is pre-programmed into the wireless mobile device to identify the subscriber and the subscriber account. Although there is no guarantee, without a separate means of validation, that a wireless mobile terminal will always be used by the subscriber of the account assigned the Subscriber Identification Code, typically the user will be the subscriber. Alternatively, the Subscriber Identification Code may be contained on a Subscriber Identity Module (SIM), also referred to in the art as a “Smart Card,” which is inserted into the wireless mobile device prior to use. The SIM or Smart Card indicates that the user of the wireless mobile terminal is the subscriber of the account assigned the Subscriber Identification Code contained on the SIM or Smart Card, or that the user has been authorized by the subscriber to use the wireless mobile terminal.

Currently, C/PCS networks are somewhat more expensive than traditional wired network communication services, referred to herein as “landline”. It has been identified that as the global markets achieve scale and become sensitive to competitive pressures, carrier networks will need to find new revenue opportunities or ways to offset carrier network subscriber charges to maintain or enhance revenue growth.

The emerging wireless mobile data services and wireless mobile global computer network services are expected to operate in a manner similar to wireless mobile telephony services, thereby creating lower overall mobile service price expectations among subscribers.

It is thus apparent that a need exists for Carrier Network Operators of wireless mobile communications services, and in particular for C/PCS to acquire a large enough number of subscribers to generate sufficient operating revenue and sufficient profit margins to remain profitable. Carrier Network Operators can most easily accomplish this by reducing subscriber service charges making their services more affordable to the masses, while maintaining profit margins. It has been suggested, without further detail that one potential means for Carrier Network Operators to achieve this goal is to offer a pricing program in which sponsors subsidize the wireless mobile communications of Carrier Network Subscribers to the service with commercial information or advertisements.

It has been suggested that Wireless Mobile Location Data included with the call signal of a wireless mobile communication can be used to determine the real-time, physical location of the subscriber. In other words, the subscriber to the service can be theoretically provided with content related to the geographical location of their wireless mobile terminal. Thus far, none of the known systems and methods for obtaining a carrier network subscriber's specific location have been utilized to provide commercial information or advertisements that are targeted to the subscriber on the basis of the Wireless Mobile Location Data included with the call signal. Ideally, any such system and content should be further refined by a series of proprietarily held demographic considerations where advertisers are participating in an auction scenario to bid for advertising priority. Further, none of the known systems and methods for capturing a subscriber's geographical location have been utilized to provide timely and localized media or to directly compensate the wireless mobile communications subscriber. It should also be recognized that it would be beneficial if geographical location information, in conjunction with timing attributes and demographic variables were combined to ensure very precise targeting capabilities to the advertiser.

Objectively, any such system should also be adaptable to function with existing legacy land line networks and the emerging Voice over Internet Protocol (VoIP) networks that currently provide an extensive and broad network of “hard wired” telephony communications generally associated with the provision of “home phone” or “business phone” services.

One objective of the present invention is to provide a system and method for providing commercial messages, advertisements and various media to an established subscriber using a wireless mobile communications service and device and/or legacy “land line” and/or Voice over Internet Protocol (VoIP) telephony equipment.

A further objective of the present invention is to provide a system and method for providing commercial information or advertisements into a wireless mobile communication device for display at the termination of each mobile “telephone call”. Alternatively or additionally, it is a system for providing commercial information or advertisements into a legacy telephone device or VoIP telephone device for display at the termination of each telephone call.

Preferably, any such commercial information or advertisement should be displayed until the receipt or placing of the next call or such time as the subscriber presses any handset or device button to terminate the display. The commercial information or advertisements being displayed being targeted to the subscriber on the basis of the Wireless Mobile Location Data included with the call signal or such location data as is selected by the advertiser and various subscriber attributes as selected by the advertiser or media content provider.

A further object of the present invention is to provide a system and method for subsidizing the cost of a wireless mobile communications service or legacy or VoIP telephony communications by providing specific incentive to the subscribers in the form of “per view” credits for advertisements as calculated by the computation and summation of completed viewing events during a communication period.

Another objective of the present invention is to provide a system and method for further targeting messages to a subscriber through a wireless mobile communications carrier network or legacy land line or VoIP communications carrier network on the basis of predetermined Subscriber Data pertaining to the subscriber and stored in an electronic database as is gathered from time to time and at the time of enrollment.

Another objective of the present invention is to provide a system and method for providing credits to the subscriber via an “E-Wallet” solution and maintaining the records within an electronic database.

Yet another objective of the invention is to permit advertisers the opportunity to participate in an auction system whereby they can determine a budget and price per ad view in targeting the subscriber population with their commercial message or advertisement.

Another objective of the invention is to enable advertisers to select from a number of demographic variables as they relate to their intended target audience in determining to which specific mobile devices the invention will deliver the advertiser's commercial message or media or to which subscribers of legacy or VoIP communications devices the invention will deliver the advertiser's commercial message or media.

It is an overall object of this invention to partially or completely fulfill one or more of the above-mentioned needs and objectives.

### SUMMARY OF THE INVENTION

(The invention consists of a method of advertising on mobile devices, comprising the steps of: a) collecting registration information from a user, the registration information including demographic, geographic and chronological information about the user; b) creating an advertising block containing one or more advertisements based on the user's demographic and geographic information; c) sending the advertising block to a mobile device designated by the user, at times determined by the user's geographic and chronological information; d) tracking and recording viewing of advertisements in the advertising block by the user; and e) compensating the user based on the viewing records for the advertisements within the advertisement block.

The method may further include an additional step of sending new advertisement blocks to the user once all advertisements in the current advertisements block have been viewed. Alternatively or additionally, a new advertisement block can be sent on a recurring basis, such as every hour or every day, regardless on whether all advertisements have been viewed in the current advertisement block.

Preferably, the size and type of the advertisements and advertisement blocks is controlled by the system, and is based on the mobile device, network carrier and subscriber preferences and demographic. Preferably, advertisements blocks are limited to 10 advertisements, with size limit on each advertisement of 100K, or 1 MB for the entire advertisement block.

(The invention further consists of a system for providing mobile device advertising, comprising: a) a media server array operative to generate inbound and outbound data signals for delivery of media to mobile devices; b) a subscriber system operative to enroll subscribers into the system and collect demographic, location and other data from each subscriber and to permits subscribers to log into the system to modify existing data, add new data, and withdraw from the system; c) a subscriber database containing all collect information about each subscriber; d) an advertiser interface system operative to enroll advertisers into the system, and permit advertisers to bid on advertisement slots and transmit advertisements to the system; e) an advertisement database containing the advertisements used by the system; and f) an advertising engine which organizes advertisements into advertising slots within advertising blocks determined by geographic location and subscriber demographic data, within advertising slots being order based on bid values received from advertisers.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a flow chart outlining a preferred method of the present invention;

FIG. 2 is a flow chart outlining an advertiser registration process according to the method of FIG. 1;

FIG. 3 is a flow chart outlining a client application structure according to the method of FIG. 1; and

FIG. 4 is a flow chart outlining an e-wallet service according to the method of FIG. 1.

### DETAILED DESCRIPTION OF THE PREFERRED EMBODIMENTS

The inventive method presented herein is based on the determination that carrier network subscribers can use the unique attributes of wireless mobile communications and, more specifically, wireless mobile communication devices, to subscribe to a system that is both permission and incentive based. The messaging service ideally will directly compensate the subscriber for their participation while providing the advertiser the ability to specifically target subscribers on the basis of physical location, demographic and time variables. It has also been determined that by utilizing the unique Subscriber Identification Code assigned to each wireless mobile device, advertisers can provide messages that are further targeted to the subscriber on the basis of predetermined data pertaining to the subscriber as gathered in accordance with the present inventive system and method and stored during the subscriber enrollment process.

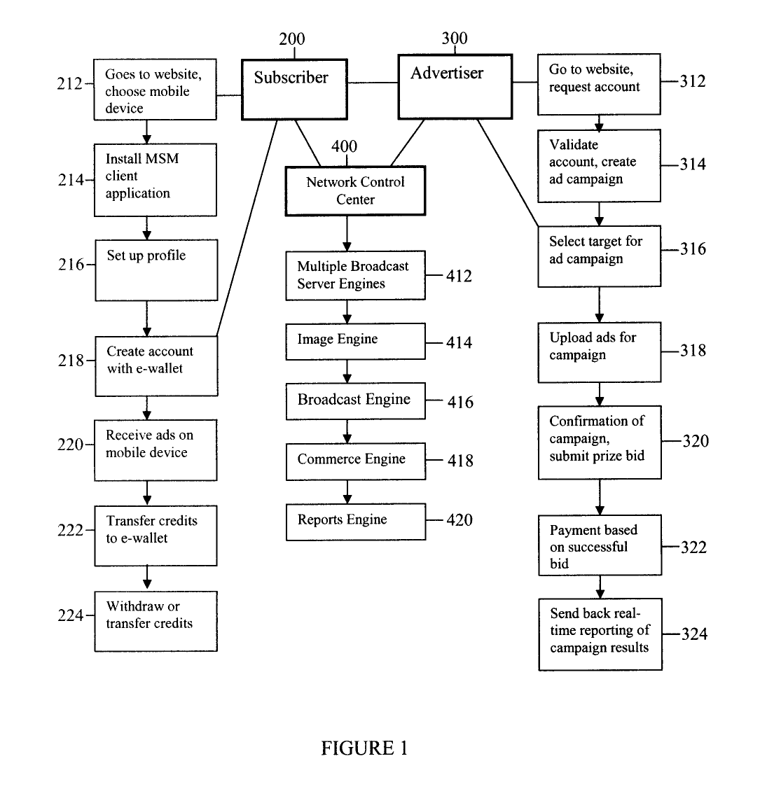

The invention relates generally to a system and method as shown in FIG. 1 for providing targeted media, and/or commercial messages, and/or advertisements to a subscriber's wireless mobile communication device, voice over internet protocol (VoIP) telephony device or legacy “land line” telephony device, irrespective of the specific network carrier. More particularly, the invention relates to a system and method for inserting at the conclusion of each “telephone call” communication, commercial information or advertisements that are targeted to the subscriber of the communication service(s). In a preferred embodiment, the messages are chosen from a database of pre-selected commercial information or advertisements and are targeted to the subscriber of the communication service(s) on the basis of highest bid price per ad view relative to the subscriber target profile data and location data included with the call signal or area code. In an alternative embodiment, the commercial information or advertisements or media are further targeted to the subscriber on the basis of predetermined Subscriber Profile Data pertaining to the individual subscriber and as provided during the subscriber's enrolment process or through subsequent subscriber survey or polling. In another embodiment, the subscriber can actively gather the commercial information or advertisements or media through a subscriber initiated platform wherein they provide an access code that prompts the immediate delivery of the selected advertisers commercial information or advertisement or media.

The subscriber 200 accesses via a website or by text (SMS) message over their mobile device (step 212) and then downloads the necessary client software to the device (step 214) and begins registration.

The subscriber 200 will provide (step 216) specific demographic information to the system during the registration process, enabling the advertisers and/or message providers with very precise targeting capabilities, in combination with available precision in timing and or geographical location of message delivery. The subscriber account is created (step 218) and the subscriber is then eligible to receive advertising on their subscribed device (step 220).

The subscriber will receive monetary or similar compensation for each ad they receive to their telephony device once the ad is viewed (step 222). Viewing of the video message or advertisement will trigger the creation of an “event” that will date and time stamp each message delivery generating the credit to the subscriber, and an update to the client/advertiser statistics and account.

Subscriber credits will be available for retrieval via a proprietary E-Wallet solution enabling subsequent withdrawal, transfer to other accounts such as PayPal, or for use as credit against cellular or carrier charges or custom content available from the system provider (step 224).

Subscribers can also “pull” special offers, coupons or advertisements in response to specific offerings via the proprietary “v-code” technology embodied within the system, providing advertisers additional unique and timely messaging opportunities. The subscriber is also provided the ability to store ads for future retrieval on their device allowing for mobile coupon or special offer campaigns with specifically measurable results and targeted to the subscriber audience.

Regular ads are loaded in blocks, preferably blocks of 10 or 12, from the system servers to the subscriber's memory enabled telephony device, and are displayed on the device screen until such time as the subscriber cancels the display, or receives or places a call. Upon call termination, the next ad in queue will display. Once the ads in queue are exhausted the ads are updated to the telephony device. Alternatively, the ads can be refreshed on an ongoing scheduled basis, such as every hour or every day.

Ad space within advertising blocks is auctioned via a bid price per subscriber view and can be specifically targeted to the mobile, home or business audience, with the highest bid price per view gaining priority placement until such time as the established budget for the campaign and time frame is exhausted, at which time the next highest bid price will take priority in the queue. As an advertiser creates or modifies a campaign they will provide input control on demographic targets, bid price per view, total budget, frequency of ad display, time and location aspects. The advertiser's ability to create on demand advertising to subscribers ranging from narrow segment or broad spectrum characteristics enables audience targeting specific to the desired reach. The advertiser will also have a selection of “premium” features to choose from in all categories enabling further refinement and special or unique message delivery options.

Reporting to the advertiser is generated via the subscriber view event, and is preferably available in real-time through the system, and will provide detailed viewer statistics whether the campaign is delivered to any one embodiment of the invention or in combination.

A delivery technology system enabling the communication to mobile devices and legacy land line or VoIP (Voice over Internet Protocol) telephony devices that have been subscriber enabled to receive such media as has been or will be developed. Currently available media option include: static (full colour) images optionally inclusive of WAP or WEB links, UPC bar codes, streaming and mpeg video, mp3/mp4 audio/video, and downloadable content (media) such as ringtones.

The system is based on use of a mobile device or land telephony device (receiving device) that is graphics and download enabled and operating within cellular signal range or on an established network as provided by the carrier network and capable of receiving a data transmission signal. The telephony device must have memory storage space capability and availability for downloaded information.

The system includes a media server array 400 capable of generating both inbound and outbound call data signal to deliver the media as specified to the receiving device. The media server array 400 includes multiple broadcast server engines 412 to conduct the operations of the system. The operations performed by the server engines 412 include: image engines 414 for converting and resizing image and other media data to meet specific device requirements; broadcast engines 416 to create and store advertising queues to be sent to subscribers; commerce engines 418 to handle credit and e-wallet transfers; and report engines 420 to provide advertiser with tracking data, including ad viewing, subscriber data, and ad campaign tracking.

The system further includes a web interface system through which subscribers can enroll into the offering (212) and download or otherwise transfer the enabling software to their receiving device (214), and through which demographic and socio-graphic information can be acquired and stored into a subscriber record (216). The voluntary enrolment process is implicit of providing advertisers or other content providers with permission to display media on to the subscriber's receiving device.

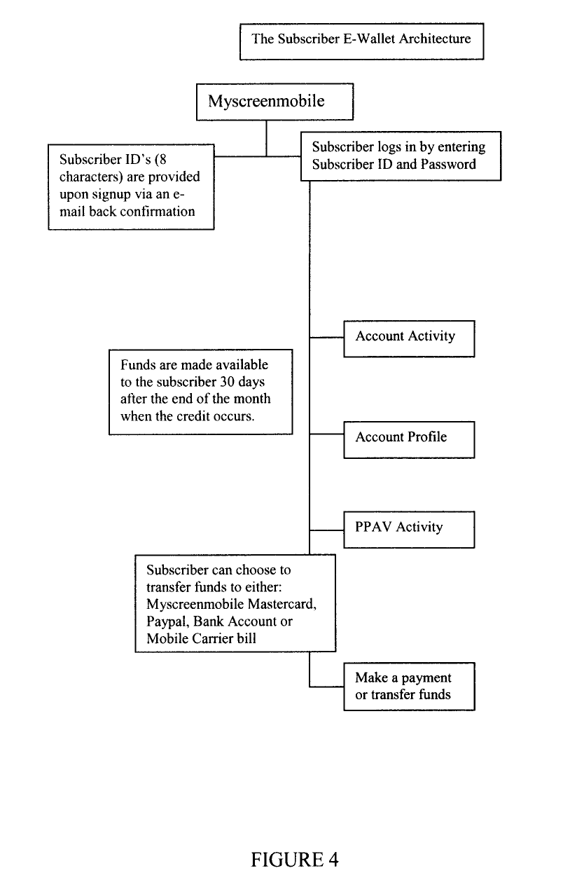

A further application of the type typically known as an “E-Wallet”, as shown in FIG. 4, is preferably included in the system for the express purpose of providing credit, preferably monetary, to the subscriber for each media viewing event captured. Such monetary compensation, coupons, discounts or other value delivered to the subscriber thus provides the “incentive” component of the system to encourage subscribers to sign up.

The system connectivity allows for unique surveying/polling opportunities where information, opinions, or viewpoints can be gathered from subscribers and categorized against precise demographic details. Preferably, subscribers will receive varying forms of incentives, linked to the e-wallet system, to complete the survey or poll.

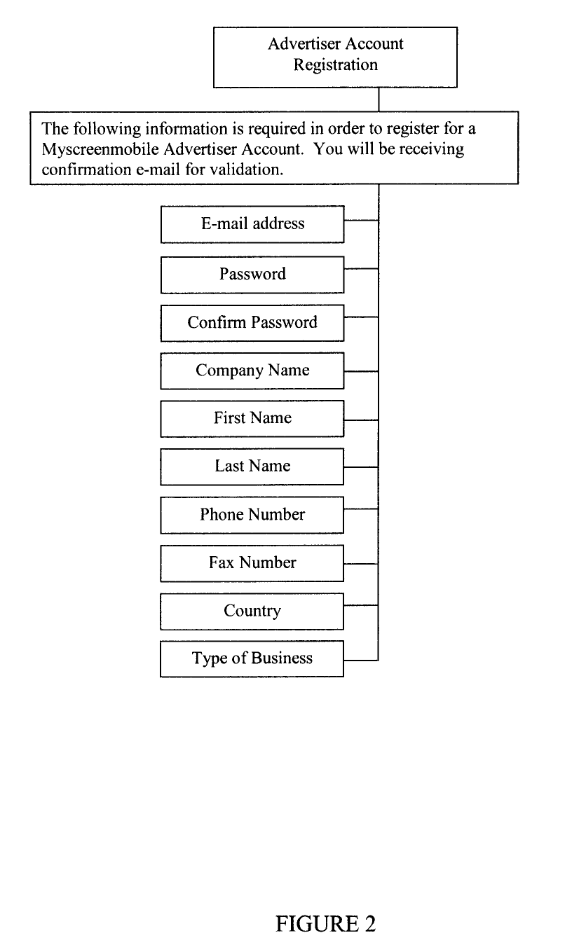

The system further includes an advertiser web interface system, as shown in FIGS. 1 and 2, through which advertisers can register (step 312), create campaigns (step 314), upload media for distribution (step 318), and manage all aspects of their campaign, budgets, and auction value bids. Extended from the advertiser web interface system, a Planning and Campaign Management System (PCMS) will additionally provide the advertiser with the ability to select (step 316) from a number of demographic and socio-graphic details stored in the subscriber database thus identifying the optimum subscriber base to receive the advertiser's media. Advertisers' abilities are restricted until payment is provided (step 322) for the proposed campaign.

Location variables may also be input for subscribers and their receiving devices creating an opportunity for advertisers to target demographic variables as described above in conjunction with the precise current mobile device location, or within select area codes or similarly regional divisions.

The media is then provided to the selected subscriber base in such fashion or schedule as the advertiser elects to participate in, within the constraints of their bid price and budget (step 320). The system further analyses the advertiser selected variables against the subscriber profiles and selects those subscriber identities that match, thus triggering the media delivery to the subscriber's receiving device.

Ideally, the system further includes a reporting system to provide statistical and demographic data to the advertiser and confirm delivery of media based upon event receipt information gathered (step 324). A further component of the reporting system includes all billing and delivery data in real-time reporting. Statistics are then retrievable by the advertiser from within their established account profile.

The system will also capture event information, where the event information communicates back the specific viewing time and device identity for compilation of advertiser statistics and subscriber incentive thus providing specifically measurable viewer results, not estimates.

### Subscriber Terms

Upon viewing, the subscriber shall, for their participation in the receipt of the content, be compensated for each event viewed, where the event is provided to the subscriber as a result of them fulfilling specified target demographics of the message provider (the advertiser) as discussed above.

Demographic data will typically include standard information such as age, gender, race and national origin, but may be enhanced to include any demographic information determined to be of impact or value to the advertising population. Personal preference data may also be collected, and would typically include general information relating to the individual preferences of the subscriber such as preferred types of food and kinds of entertainment, as well as any hobbies or interests the subscriber may have. Whenever applicable, the predetermined Subscriber Data may also include psychographic data obtained and selected in a similar manner through the initial data gathering process or through subsequent survey. In a preferred embodiment of the invention, the messages can be further targeted to the subscriber data identified by the Subscriber Identification Code on the basis of the Subscriber Profile Data in combination of any of the listed variables.

Furthermore, where the subscriber is engaged to initiate the receipt of specific messages, value ads, coupons, incentives or content via provision of a “v-code”, a proprietary system using 5 digit “call codes”, from the subscriber to the server resulting in the transmittal or download of the requested content the subscriber for said event the compensation provided is in the form of the content or incentive received through the download.

Credit amounts generated to the subscriber and stored in their e-wallet are provided at the sole discretion of the provider, and may be amended from time to time, and varied according to content received. Limits may be applied to subscribers, either to total credits, or credits received from a specific advertiser.

The provider may from time to time poll the subscriber for additional demographic information, and make this information available to advertiser's in general statistical terms and for use within the campaign management system for the purpose of segment or target definition.

As a subscriber it is accepted that the provider will from time to time, and as often as the provider deems necessary, communicate blocks of media (as described above) to the subscribers receiving device. The media is displayed on the device at the conclusion of each inbound or outbound telephone communication event, for the duration the subscriber allows the display to continue, or until such time as another inbound or outbound telephone communication event occurs. The subscriber can cancel the display of any media by depressing any key on their device, returning their screen to their pre-selected “home screen”.

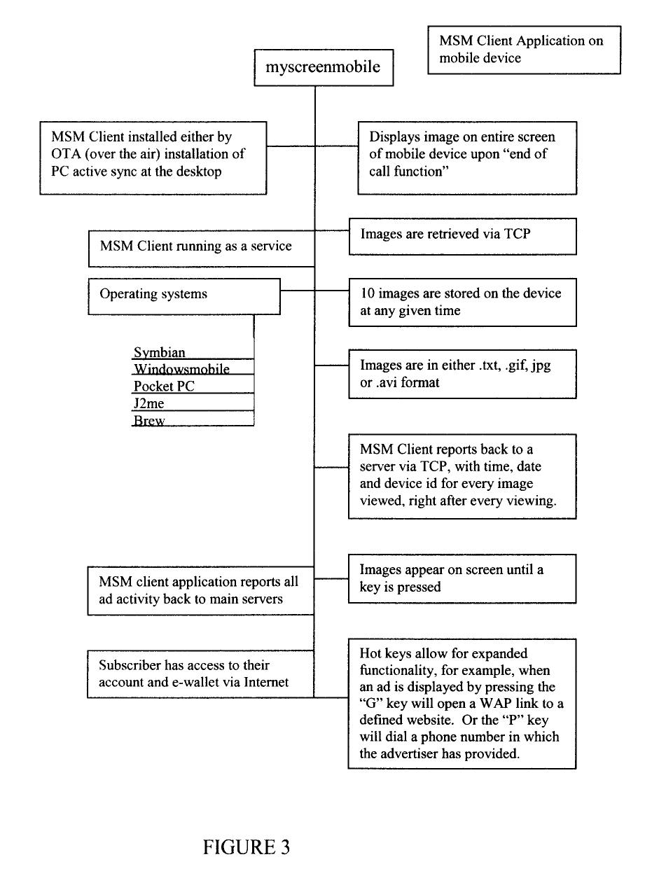

The media is communicated, as shown in FIG. 3, to the receiving device in “blocks” of media events, each block equaling 10 or a similar number of media messages or advertisements. Media blocks are updated as needed, or hourly, daily, or some other regularly scheduled basis, depending upon the overall activity among advertisers and their campaigns. Subscribers receive unique media blocks to their device in accordance with the selected variables input by the advertiser while establishing the campaign within the PCMS. As new ads are “pulled down” by the device they will replace the previous ad blocks.

Once loaded, a media event can not be withdrawn by the provider and will remain in queue until such time as it is displayed and the event recorded thus generating the credit to the subscriber recipient. The subscriber shall receive credit for each media viewing event within limits established and amended from time to time by the system provider. Within the discretion of the provider, credits for media events may be changed or forfeited at any time.

Further, the system and method of the invention permit the subscriber to interactively respond to a message provided to the subscriber, or to initiate an inquiry for additional information from the inventor of the service or from the advertiser. For example, the subscriber could request the inventor or advertiser to insert another message into the wireless mobile communication device, to forward an audio, video or electronic data copy or such media as may be contemplated, or a copy of a previously provided message to an electronic message input, storage and retrieval database within the mobile device, or to establish a direct telecommunications or other data link with a representative of the advertiser, such as a telemarketer or through WAP or WEB browser. The subscriber may respond to the advertiser's query and the advertiser may fulfill the subscriber's request immediately following a particular message, immediately following a group of messages or following the conclusion of the wireless mobile communication or at such time as the subscriber designates or determines.

Specific software applications to enable the system as provided to the subscriber as a part of their subscription are dependant upon the receiving device and equipment in use. The device will then be enabled with operational features and screen icons to facilitate user functionality. Additionally, the advertisements can include code that modifies the keys on the device to perform actions associated with the advertisement. For example, an advertisement can include code that links the ‘p’ key on the device to a phone number associated with the advertisement, such as the advertiser's contact number, or a call-in entry number for a contest associated with the advertisement. Other potential actions include a key to activate a WAP or an Internet connection, to access a website mention in the advertisement, or to bring up an address book to automatically enter information contained in the advertisement.

“Request V-Code” will open the user interface wherein they will provide the 5 digit code specific to the campaign or offering they are wishing to obtain.

“Cancel” will delete the request.

“Stored Ads” will enable the subscriber to retain selected media within their device for future retrieval or coupon redemption, etc. Under the “Stored Ads” icon will be options to “view ad”, “Close” and “Delete”.

“View Ad” will display the ad on screen and will provide the further options to “Close” or “Delete”. Selecting “Close” will cancel the display and retain the item in the “Stored Ads” list. “Delete” will cancel the display and remove the media from the “Stored Ads” list.

Once a subscriber is enrolled they are active and have granted permission to the advertising population to provide media to their device, and have agreed to accept incentive and payment in compensation for the permission granted. Permission may be withdrawn at any time through the cancellation of the service. An active subscriber will, based upon advertiser selection of the appropriate demographic information that corresponds to the subscriber begin, to receive media for display on their mobile or legacy/VoIP telephony device.

### Advertiser Terms

The advertiser is provided with several fully integrated systems to create and control their campaigns.

PCMS is the “Planning and Campaign Management System” and is the portal through which all non-monetary aspects of the advertiser's campaign are managed. Variables selected within the PCMS define the delivery specifications of the target audience through a series of inputs and drop down lists.

Source media is “uploaded” through the PCMS for distribution to the selected target audience. Media content can be limited to in size, such as 1 Mb capacity for each campaign, and also limited to type i.e. video only, stills only, ads only. Media prepared for distribution through the PCMS will be validated and approved by the system provided prior to distribution.

Additional delivery variables such as time variables, location variables, and repeat variables are also managed through this system. Advertisers can select from “balanced broadcast” or “immediate broadcast” which will determine the “spread” of the campaign in terms of delivery timing.

The PCMS is reliant upon information controlled through the information gathered and integrated by way of the OBS (Online Billing System). It is the OBS that controls the overall pre-determined budget for the campaign and the auction value or bid price established for the ad view (a pay-per-ad view system—PPAV).

The system will perform ongoing sorts through all submitted and approved media content relative to the target criteria and based upon the highest value PPAV that content will be made available to the subscriber's device for download with the next block, and will rank the priority of time view (i.e. 1st of 10 media viewed through 10th of 10 media to be viewed).

As variables are selected from both systems the engine will create and update an active audience size number for the advertiser to be aware of distribution reach.

E-Wallet Terms

Each subscriber will automatically establish an “E-Wallet” relationship with the system provider. The E-Wallet as will be proprietarily provided to capture the credits as earned by the subscriber for participating in the system according to the sequence shown in FIG. 4.

Credits will be generated as a component of the viewing event process as an element of the PPAV bid within the OBS. Additional credits can be gained for non-event activities, such as for referrals, forwarded ads, premium content receipt or survey/poll responses.

### Media Selection Terms

Media will be selected for display on a hierarchy basis of combined variables. Top priority in the hierarchy is given to the bid value by the advertiser, or “Price per ad view”. Time sensitivity and location sensitivity will also factor into the creation of display strings of media. Each display string will update or re-load upon expiry of the string, or hourly, whichever is sooner. Update and re-load parameters are device-dependent, reflecting the memory capacity and hardware capabilities of the mobile device. The media for the display string is stored in a subscriber folder on the system server and is customized to match the specifications of the mobile device as it is loaded into the folder. The media provided to the mobile device will be stored in memory on the mobile device until viewed.

Once each specific media is viewed, an event is captured that reports to the advertiser and to the subscriber's E-wallet in the form of compensation for the ad view for the subscriber, and statistical update for the advertiser and adjustment to the remaining budget for the advertiser.

Each time a subscriber terminates a call using their receiving device, the next priority media will display. Such display will remain on screen until a further action is taken with the mobile device to either remove it from screen (by simply depressing any key) or by the placing or receiving of another mobile call.

Viewed ads may also be stored for future retrieval within the device, of particular value to the subscriber where the media includes special offers or coupons for redemption.

The specifically measurable results generated as through the media viewing event tabulations gives advertisers unprecedented viewership statistics. Further precision is enabled through the downloadable coupon or such other media as may be stored and retrieved at a future time or date that can be further captured at point of sale or transaction for the advertiser or their client.

Media provided can be provided in all known and contemplated formats to a maximum file size (e.g. 1 Mb) per commercial message or advertisement or total advertisement block. Similar media type (still image, video, audio/video) can also be restricted by the system, based on the advertiser's terms. Media is delivered to the receiving telephony device in strings or blocks, preferably of 10 ads per block, that are stored in the memory of the device until displayed.

The subscriber may designate those media that it wishes to retain within the memory of their receiving device as a “stored ad” and may retrieve the saved media at any time. Once media is viewed, unless a repeat has been designated by the advertiser, the subscriber is not credited for any subsequent viewings as a viewing event will not be captured.

While the above method has been presented in the context of mobile and landline/legacy telephony devices the method is equally applicable to other communication systems and devices, such as email, personal computers, televisions, and other devices and systems.

This concludes the description of a presently preferred embodiment of the invention. The foregoing description has been presented for the purpose of illustration and is not intended to be exhaustive or to limit the invention to the precise form disclosed. It is intended the scope of the invention be limited not by this description but solely by the claims that follow.

What is claimed is:

1. A method of advertising on mobile devices, comprising the steps of:
a) collecting registration information from a user, the registration information including demographic, geographic and chronological information about the user;
b) creating an advertising block containing one or more advertisements based on the user's demographic and geographic information;
c) sending the advertising block to a mobile device designated by the user, at times determined by the user's geographic and chronological information;
d) displaying the advertisements upon termination of a call on the mobile device;
e) tracking and recording viewing of advertisements in the advertising block by the user; and
f) compensating the user based on the viewing records for the advertisements within the advertisement block.

2. The method of claim 1, further including a step of transferring an advertising viewing application to the mobile device after completion of the registration step.

3. (canceled)

4. (canceled)

5. The method of claim 1, comprising the further step of sending a new advertising block once all advertisements in the current advertisement block have been viewed.

6. The method of claim 5, wherein a new advertisement block is sent every hour, regardless of whether all advertisements in the current advertisement block have been viewed.

7. The method of claim 6, wherein a new advertisement block is sent every day, regardless of whether all advertisement in the current advertisement block have been viewed.

8. The method of claim 1, wherein advertisements within an advertisement block are provided to advertisers on an auction basis.

9. The method of claim 8, wherein advertisements are subsequently ranked for viewing within the advertisement blocks based on auction price.

10. (canceled)

11. (canceled)

12. (canceled)

13. The method of claim 1, wherein the advertisements are limited to still pictures only.

14. The method of claim 1, wherein the advertisements are limited to fixed-length audio/video clips only.

15. (canceled)

16. (canceled)

17. The method of claim 1, wherein the advertisements can include coupons and discount offers that are separately activated by the subscriber.

18. The method of claim 17, wherein the coupons and discount offers are available for offline use by the subscriber.

19. A system for providing mobile device advertising, comprising:
a) a media server array operative to generate inbound and outbound data signals for delivery of media to mobile devices;
b) a subscriber system operative to enroll subscribers into the system and collect demographic, location and other data from each subscriber and to permit subscribers to log into the system to modify existing data, add new data, and withdraw from the system;
c) a subscriber database containing all collected information about each subscriber;
d) an advertiser interface system operative to enroll advertisers into the system, and permit advertisers to bid on advertisement slots and transmit advertisements to the system;
e) an advertisement database containing the advertisements used by the system; and
f) an advertising engine which organizes advertisements into advertising slots within advertising blocks determined by geographic location and subscriber demographic data, within advertising slots being ordered based on bid values received from advertisers.

20. The system of claim 19, further including an e-wallet system to provide compensation to subscribers for viewing advertisements and to enable subscribers to collect such compensation.

21. (canceled)

22. (canceled)

23. The system of claim 19, wherein the media server array is operative to transmit a new advertising block in response to a signal indicating that a current advertising block has been viewed.

24. The system of claim 19, wherein the media server array is operative to transmit a new advertising block every day independently of viewing status of a current advertising block.

25. The system of claim 19, wherein the media server array is operative to transmit a new advertising block every hour independently of the viewing status of a current advertising block.

26. The system of claim 19, further comprising:
g) an image engine for converting and resizing images and other media data to meet specific device requirements.

27. The method of claim 1, wherein the advertisement additionally operates to assign actions to specific keys on the mobile device.

28. The method of claim 27, wherein one of the assigned actions is to call a specific phone number associated with the advertisement.

29. (canceled)

30. A method of advertising on a mobile device, comprising:
detecting termination of a call on said mobile device; and
displaying an advertisement on said mobile device in response to said detecting.
